(19) United States
(12) Patent Application Publication
(10) Pub. No.: US 2002/0142656 A1
(43) Pub. Date: Oct. 3, 2002

(54) Connector and metal grounding shell arrangement

(76) Inventor: Chih-Kai Chang, Sanchung City (TW)

Correspondence Address: BACON & THOMAS, PLLC, 625 Slaters Lane, 4th Floor, Alexandria, VA, 22314-1176, US

(21) Appl. No.: 09/818,677

(22) Filed: Mar. 28, 2001

(51) Int. Cl. H01R 13/648

(52) U.S. Cl. 439/607

(57) ABSTRACT

A connector and metal grounding shell arrangement includes a metal grounding shell and an electric connector mounted in the metal grounding shell, the electric connector having a circuit board vertically disposed at near a rear side thereof and a plurality of terminals respectively extended from a front sidewall of the circuit board, the circuit board having a thin-film grounding contact disposed at a back sidewall thereof, the metal grounding shell having a spring contact strip protruded from a back sidewall thereof and pressed on the thin-film grounding contact of the circuit board to form a grounding loop.

### BACKGROUND OF THE INVENTION

The present invention relates to electric connectors, and more specifically, to a connector and metal grounding shell arrangement, which forces the electric connector and the metal grounding shell to form a grounding loop automatically when assembled.

Following fast development of computer technology, advanced desktop and notebook computers have been continuously developing. In consequence, a variety of electric connectors have been disclosed for use with computers. During signal transmission through a computer connector, external electromagnetic interference and internal static interference must be eliminated. In order to eliminate these interferences, regular computer connectors are commonly equipped with a metal shield (metal grounding shell). FIGS. 6 and 7 show a prior art design. According to this design, the terminal holder is directly soldered to the circuit board. This design effectively eliminates the interference of external electromagnetic waves. However, this design cannot eliminate internal static interference. There are known another two measures to eliminate the problem of external electromagnetic interference and internal static interference. One measure is to directly solder a grounding wire to the grounding terminal of the circuit board of the electric connector and the metal shield covering the electric connector. This measure complicates the fabrication procedure of the electric connector, and also greatly increases the manufacturing cost of the electric connector. The other measure is the use of an electrically conductive cloth to connect the grounding contact of the circuit board of the electric connector to the metal shield. This measure also complicates the fabrication procedure of the electric connector and increases the manufacturing cost of the electric connector.

### SUMMARY OF THE INVENTION

The present invention has been accomplished to provide a connector and metal grounding shell arrangement, which eliminates the aforesaid drawbacks. It is the main object of the present invention to provide a connector and metal grounding shell arrangement, which automatically forces the grounding contact of the circuit board of the electric connector into contact with the metal grounding shell after installation of the electric connector in the metal grounding shell. According to the present invention, the circuit board of the electric connector has a thin-film grounding contact disposed at a back sidewall thereof, and the metal grounding shell has a spring contact strip protruded from a horizontal top flange of the back sidewall thereof. After installation of the electric connector in the metal grounding shell, the spring contact strip of the metal grounding shell is automatically pressed on the thin-film grounding contact of the circuit board, forming with the circuit board a grounding loop to eliminate internal static interference and external electromagnetic interference.

### BRIEF DESCRIPTION OF THE DRAWINGS

FIG. 1 is an exploded view of a metal grounding shell according to the present invention.

FIG. 2 is a side view in section of the present invention before the assembly process.

FIG. 3 is another side view in section of the present invention showing the electric connector inserted into the base frame of the metal grounding shell before contact of the thin-film grounding contact of the circuit board with the spring contact strip of the base frame of the metal grounding shell.

FIG. 4 is similar to FIG. 3 but showing the thin-film grounding contact of the circuit board forced into contact with the spring contact strip of the base frame of the metal grounding shell.

FIG. 5 is similar to FIG. 4 but showing the face panel fixedly fastened to the base frame.

FIG. 6 is an exploded view of the prior art design.

FIG. 7 is another exploded view of the prior art design.

### DETAILED DESCRIPTION OF THE PREFERRED EMBODIMENT

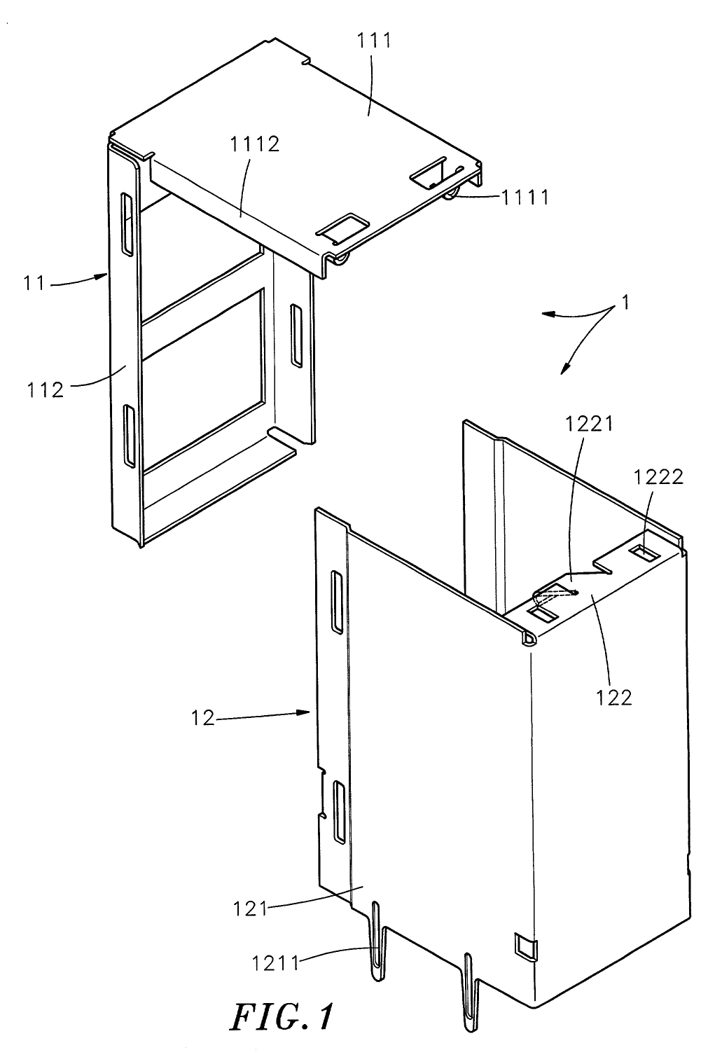

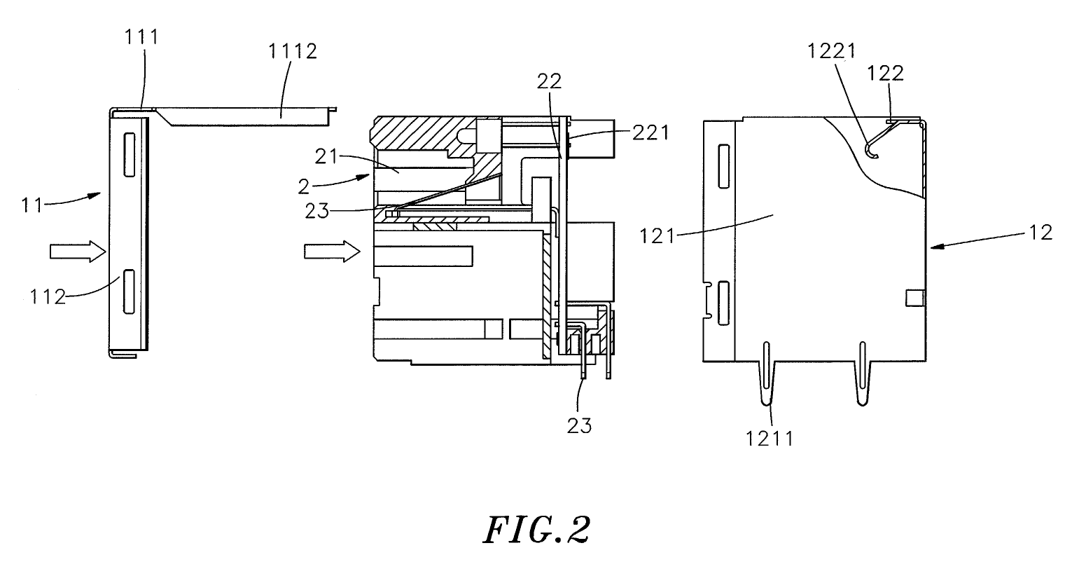

Referring to FIGS. 1 and 2, the present invention comprises a metal grounding shell 1, and an electric connector 2. The metal grounding shell 1 is a rectangular, bottom-open metal case comprised of a face panel 11 and a base frame 12. The face panel 11 is a substantially L-shaped metal frame comprising a horizontal top sidewall 111 backwardly extended from the top side thereof, two downward flanges 112 respectively extended along two opposite lateral sides of the top sidewall 111, two hooks 1111 downwardly protruded from the top sidewall 111 between the downward flanges 112 near the rear side of the top sidewall 111, and three backward flanges 112 respectively backwardly extended along the bottom and two opposite lateral sides thereof. The base frame 12 is a substantially U-shaped metal frame comprising two parallel sidewalls 121, two pairs of grounding legs 1211 respectively downwardly extended from the sidewalls 121, a horizontal top flange 122 forwardly extended from the top side thereof between the sidewalls 121, a spring contact strip 1221 downwardly protruded from a middle part of the horizontal top flange 122, and two hook holes 1222 pierced through the horizontal top flange 122 at two sides of the spring contact strip 1221 corresponding to the hooks 1111 of the face panel 11. The spring contact strip 1221 preferably has a front end rolled up for easy contact with the thinfilm grounding contact 221 of the circuit board 22. The electric connector 2 comprises a receiving chamber 21, and a circuit board 22 mounted in the receiving chamber 21 at a rear side, and a plurality of terminals 23 respectively soldered to respective contacts (not shown) at the front sidewall of the circuit board 22. The circuit board 22 has a thin-film grounding contact 221 disposed at the back sidewall thereof.

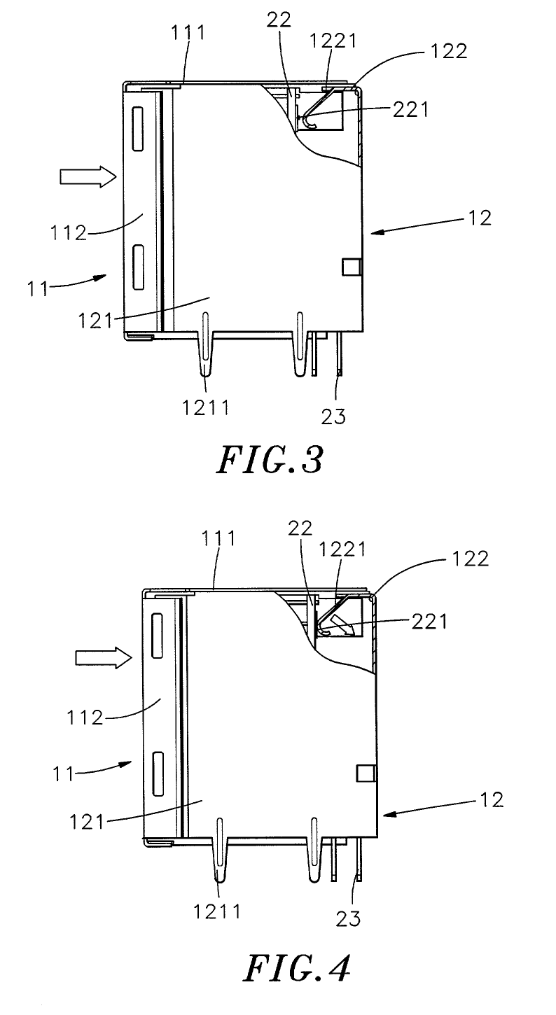

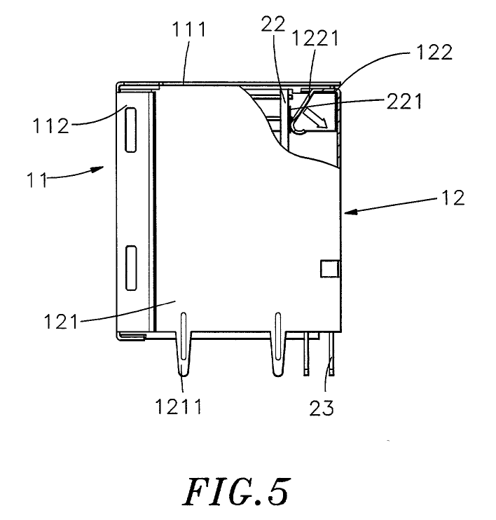

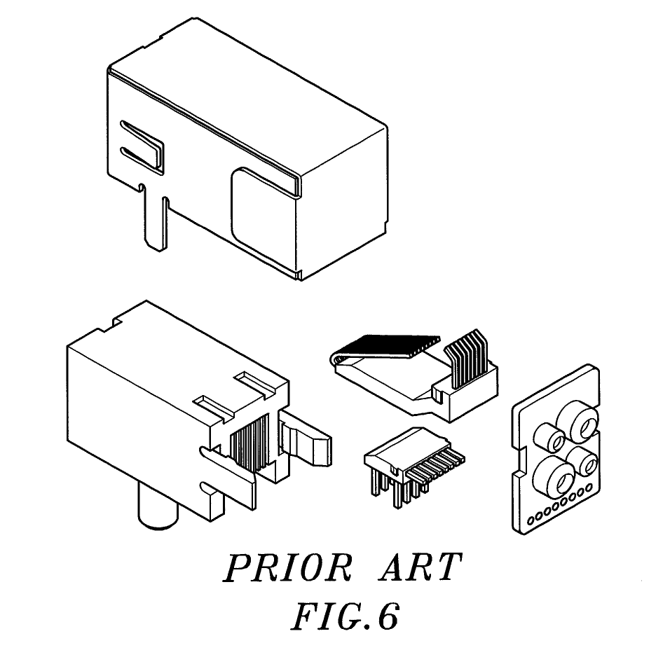

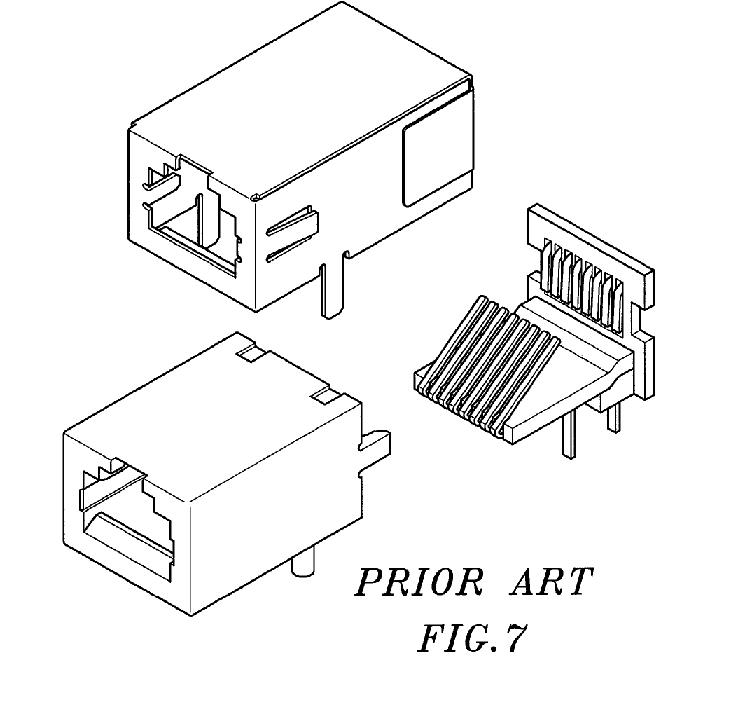

The assembly process of the present invention is outlined hereinafter with reference to FIGS. from 3 through 5 and FIGS. 1 and 2 again, at first, the electric connector 2 is inserted into the base frame 12 between the sidewalls 121. At this time, the thin-film grounding contact 221 does not touch the spring contact strip 1221 of the base frame 12 (see FIG. 3.). Thereafter, the face panel 11 is fastened to the base frame 12 to push the electric connector backwards, forcing the thin-film grounding contact 221 into contact with the spring contact strip 1221 of the base frame 12, and then the hooks 1111 of the face panel 11 are respectively hooked in the hook holes 1222 of the horizontal top flange 122 of the base frame 12 (see FIGS. 4 and 5).

As indicated above, after installation of the metal grounding shell in the electric connector, the grounding contact of the electric connector is directly maintained in contact with the spring contact strip of the base frame of the metal grounding shell. Because no further grounding terminal soldering procedure is required, the installation of the present invention is simple and, the manufacturing cost is relatively reduced. Further, because the thinfilm grounding contact is provided at the back sidewall of the circuit board and directly forced into contact with the spring contact strip of the base frame of the metal grounding shell after installation of the present invention, there is no limitation to the circuit design at the front sidewall of the circuit board.

A prototype of connector and grounding shell arrangement has been constructed with the features of FIGS. 1˜5. The connector and grounding shell arrangement functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A connector and metal grounding shell arrangement comprising a metal grounding shell having a bottom opening and a plurality of grounding legs disposed at two sides of said bottom opening, and an electric connector mounted in said metal grounding shell, said electric connector comprising a circuit board, and a plurality of terminals respectively soldered to said circuit board and extended out of said bottom opening, wherein said circuit board comprises a thin-film grounding contact disposed at a back sidewall thereof, and said metal grounding shell comprises a spring contact strip protruded from a back sidewall thereof and pressed on said thin-film grounding contact of said circuit board to form a grounding loop.

2. The connector and metal grounding shell arrangement of claim 1 wherein said metal grounding shell is comprised of a base frame and a face panel covered on said base frame.

3. The connector and metal grounding shell arrangement of claim 2 wherein said face panel of said metal grounding shell has a L-shaped profile.

4. The connector and metal grounding shell arrangement of claim 2 wherein said base fame of said metal grounding shell has a U-shaped profile.

5. The connector and metal grounding shell arrangement of claim 2 wherein said base frame comprises a plurality of hook holes, and said face panel comprises a plurality of hooks respectively hooked in the hook holes of said base frame.

6. The connector and metal grounding shell of claim 1 wherein said spring contact strip has a front end rolled up.

7. The connector and metal grounding shell of claim 2 wherein said face panel comprises two downward flanges respectively extended along two opposite lateral sides of a horizontal top sidewall thereof and respectively attached to two opposite lateral sidewalls of said base frame at an inner side.

8. The connector and metal grounding shell of claim 2 wherein said face panel comprises two backward flange respectively stopped attached to two opposite lateral sidewalls of said base frame at an inner side.
